(19) United States
(12) Patent Application Publication
(10) Pub. No.: US 2005/0186943 A1
(43) Pub. Date: Aug. 25, 2005

(54) System and method for voicemail retrieval notification

(75) Inventors: Peggy Hasan, Aurora, IL (US); Sandra Lynn True, St. Charles, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2518, US

(73) Assignee: Lucent Technologies Inc.

(21) Appl. No.: 10/786,730

(22) Filed: Feb. 25, 2004

(51) Int. Cl. H04M 11/00; H04M 11/10

(52) U.S. Cl. 455/413; 455/412.1; 455/466

(57) ABSTRACT

A method of message delivery using a wireless communications network includes sending a voicemail retrieval notification acknowledgement message to a calling party indicating that a called party has retrieved the calling-party-to-called-party voicemail message. A system for voicemail retrieval notification includes means for sending a voicemail retrieval notification acknowledgement message to the calling party indicating that the called party has retrieved the calling-party-to-called-party voicemail message.

### BACKGROUND OF THE INVENTION

This invention relates to the art of telecommunications and more particularly to a system and method for notifying a calling party that a called party has retrieved their voicemail message.

Telecommunications networks, including wireless communications networks, provide a voicemail system to enable a calling party to leave a message for a called party when the called party is already on the line or not available to answer the incoming call. The voicemail system sends the voicemail message to the called party whenever the called party indicates to the voicemail system that they want to retrieve the message.

However, after leaving the voicemail message to the called party, the calling party does not know if called party has retrieved the voicemail message and when. Typically, the calling party must wait for the called party to contact them in response to the voicemail message before the calling party knows that the called party has received their voicemail message.

It is desirable to provide notification to the calling party that the called party has retrieved the voicemail message.

### SUMMARY OF THE INVENTION

A system and method of message delivery using a wireless communications network is provided.

In one aspect of the invention, the method includes leaving a calling-party-to-called-party voicemail message on the wireless communications network voicemail system, retrieving the voicemail message by the called party, and sending a voicemail retrieval notification acknowledgement message to the calling party indicating that the called party has retrieved the calling-party-to-called-party voicemail message.

In another aspect of the invention, the system includes means for sending a voicemail retrieval notification acknowledgement message to the calling party indicating that the called party has retrieved the calling-party-to-called-party voicemail message.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram illustrating a portion of a wireless communications network in accordance with the invention;

FIG. 2 is a flow chart illustrating the invention;

FIG. 3 is a message flow in accordance with the invention;

FIG. 4 is a flow chart illustrating the invention;

FIG. 5 is a message flow in accordance with the invention; and

FIG. 6 is a message flow in accordance with the invention.

### DETAILED DESCRIPTION OF THE PREFERRED EMBODIMENTS

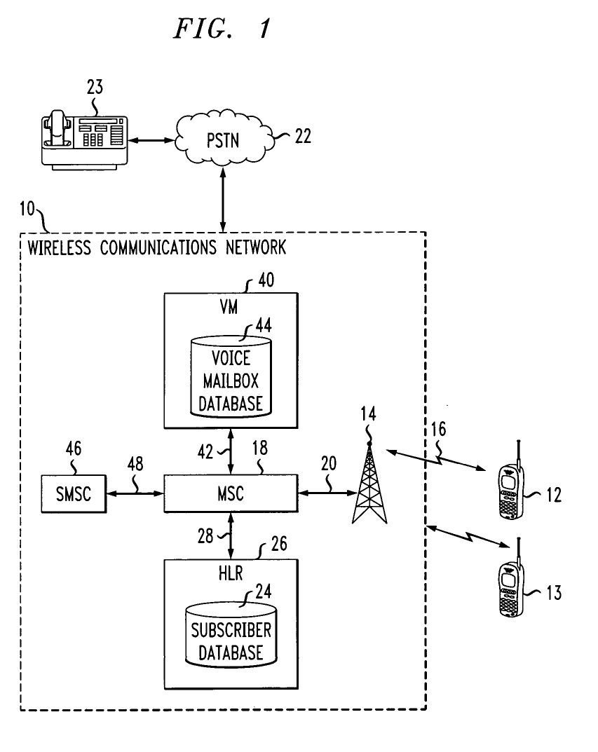

Referring to FIG. 1 a block diagram of a portion of a wireless communications network shown generally at 10. The wireless communications network 10 can be any suitable known wireless communications network including but not limited to CDMA, GSM, etc.

A wireless communications service provider provides the services of the wireless communications network 10 to subscribers. A subscriber can communicate over the wireless communications network 10 using a wireless communications terminal 12. The wireless communications terminal 12, also known as a cellular terminal, can be capable of sending and/or receiving various media such as data, text, special applications, video, etc., as well as voice communications using the wireless communications network 10. Examples of the wireless communications terminal 12 can include, but are not limited to, CDMA, GSM, or any other wireless devices capable of using the wireless communications network 10. For the purposes of example as shall be described in further detail below, the wireless communications terminal 12 is referred to herein as the calling party terminal.

The wireless communications network 10 includes a base station 14 communicating with the calling party terminal 12 over an air interface 16. The wireless communications network 10 also includes a Mobile Switching Center (MSC) 18 communicating with the base station 14 using any suitable known connection 20. The MSC 18 handles the communications of the calling party terminal 12 with the communications network 10 including call set-ups, registration and routing calls to the calling party terminal. In the preferred embodiment, the MSC 18 is a processor-based apparatus with data link interfaces for coupling together other portions of the wireless communications network 10 which are not shown. The MSC 18 can be the calling party terminal's home MSC, or it can be a different MSC in the wireless communications network 10, often referred to a the serving MSC, if the calling party terminal 12 is roaming.

The wireless communications network 10 provides communications between wireless terminals, such as the wireless terminal 12 and another wireless terminal 13. Other terminals, such as landline terminal 23, can communicate over the wireless network 10 via the PSTN 22.

The wireless communications network 10 also includes a subscriber database 24 also known as the subscriber profile. The subscriber database 24 includes stored subscriber profile information, which includes identification of the services the network subscribers subscribe to, such as call waiting as well as the services provided by the invention as described below. The subscriber database 24 can be stored on any suitable node in the wireless communications network 10. By way of example, which should not be considered limiting, the subscriber database 24 can be stored on the Home Location Register (HLR) 26. The HLR 26 is connected to the MSC 18 in a known manner at 28. The HLR 26 can also store information such as user identification, user security information, including network access control information for authentication and authorization, user location information for user registration, etc.

The wireless communications network 10 also includes a voicemail system 40 connected to the MSC 18 in a known manner at 42. The voicemail system 40 stores voicemail messages made by the calling party which are destined for the called party, referred to herein as calling-party-to-called-party voicemail messages, on a voice mailbox database 44. The called party can access the voicemail system 40 and retrieve voicemail messages left for them on the voice mailbox database 44 via the wireless network 10.

The wireless communications network 10 can also include a Short Message Service Center (SMSC) element 46 connected to the MSC 18 at 48 for delivering SMS messages to wireless terminals 12, 13. The SMSC 46 provides a mechanism for transmitting SMS messages to and from wireless terminals via the home/serving MSC 18. The SMSC 46 acts as a store-and-forward system for SMS messages, providing the mechanisms required to find the subscriber terminal MSC 18 for transport of SMS messages therebetween.

SMS makes use of the mobile application part (MAP), which defines the methods and mechanisms of communication in wireless networks and employs the services of the SS7 transactional capabilities application part (TCAP). The capabilities of the wireless terminal 12 can vary depending on the wireless technology supported by the terminal. The MAP layer defines the operations necessary to support SMS. Both American and international standards bodies have defined a MAP layer using the services of the SS7 TCAP. The American standard is published by Telecommunication Industry Association and is referred to as IS-41. The international standard is defined by the European Telecommunications Standards Institute (ETSI) and is referred to as GSM MAP.

In accordance with the invention, a calling party calls a called party. The calling party leaves a calling-party-to-called-party voicemail message on the voicemail system 40. For the purposes of simplicity and example, which should not be limiting, the calling party is using the wireless terminal 12, although the calling party terminal can be a wireline terminal 23 connected to the wireless network 10 via the PSTN 22. Also, for the purposes of simplicity and example, which should not be limiting, the called party is using the wireless terminal 13, although the called party terminal can be a wireline terminal 23 connected to the wireless network 10 via the PSTN 22. Further, for the purposes of simplification in the examples and description provided herein and unless stated otherwise, delivering information and/or a message to the calling party also refers to delivering the information and/or message to the calling party terminal 12 and delivering information and/or a message to the called party also refers to delivering the information and/or message to the called party terminal 13.

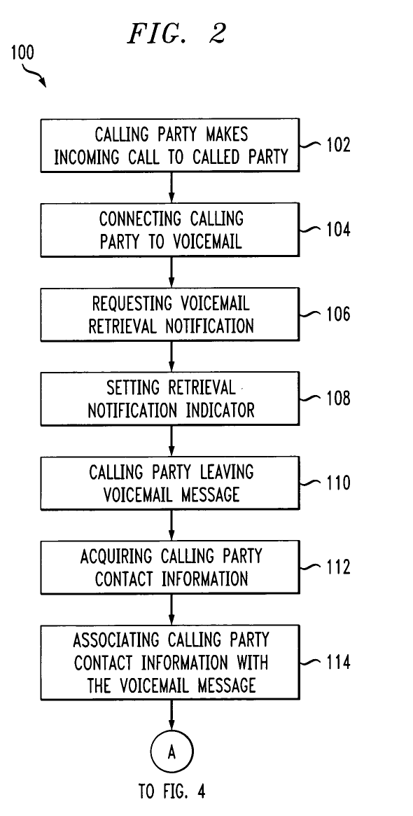

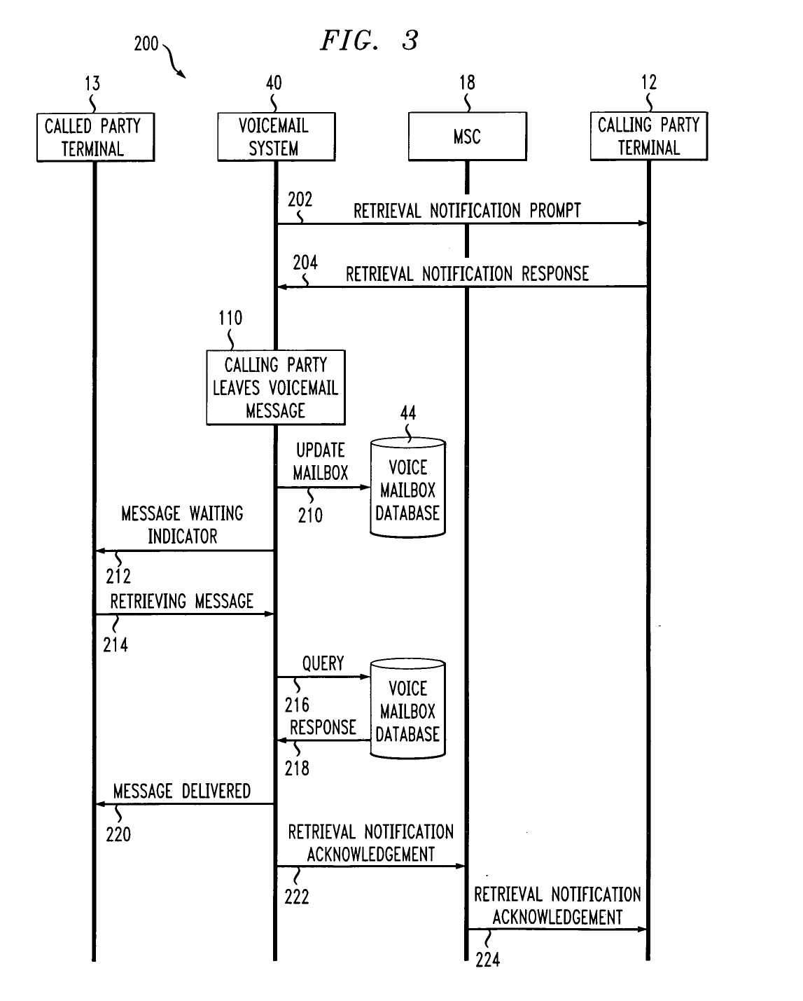

Referring now to FIGS. 2 and 3, a method of message delivery using a wireless communications network is shown generally at 100. The method 100 includes the calling party placing a call, referred to as the incoming call, to the called party at 102 using the calling party terminal 12. The method 100 also includes connecting the calling party terminal 12 to the voicemail system 40 at 104 thereby connecting the calling party with the called party's voicemail. The calling party may reach the voicemail system 40 for a variety of reasons including, but not limited to, the called party being unavailable to answer the called party terminal 13, the called party already using the line, the called party terminal 13 being turned off, etc.

The method 100 also includes the calling party requesting voicemail retrieval notification at 106. The voicemail system 40 can send a Retrieval Notification Prompt message to the calling party terminal 12 inquiring whether the calling party would like to be notified when the called party retrieves their voicemail message.

A message flow diagram is shown generally at 200 in FIG. 3. The message flow 200 includes the voicemail system 40 sending the Retrieval Notification Prompt message to the calling party terminal 12 at 202. The Retrieval Notification Prompt message 202 can include verbal prompt asking the calling party if they would like to request Voicemail Retrieval Notification, if so press a key, such as for example 1, on their terminal 12. The calling party requests Voicemail Retrieval Notification by pressing 1 sending a Retrieval Notification Response back to the voicemail system 40 at 204.

The voicemail system 40 could also obtain the voicemail retrieval notification acknowledgement message delivery preference from the calling party. The voicemail system 40 could ask the calling party how they would like to receive the voicemail retrieval notification acknowledgement message indicating that the called party has retrieved their message. The calling party could indicate their preference such as for example, an audio message, an SMS message, or a voicemail message,

The method 100 also includes the voicemail system 40 setting a Retrieval Notification Indicator, such as for example a flag, at 108 indicating that the Voicemail Retrieval Notification feature has been activated for the calling-party-to-called-party voicemail message that the calling party is leaving on the voicemail system 40.

The method 100 also includes the calling party leaving a calling-party-to-called-party voicemail message on the voicemail system 40 as shown at 110. The calling party leaves the voicemail message by recording a voice message on the voicemail system 40 using the calling party terminal 12.

The method 100 also includes the voicemail system acquiring calling party contact information at 112. The calling party contact information can include the phone number of the calling party terminal 12. The calling party phone number is left with the voicemail system 40 when the calling party leaves the calling-party-to-called-party voicemail message.

The calling party contact information is associated with the calling-party-to-called-party voicemail message at 114. The calling party contact information, including the calling party phone number, can be stored in the voice mailbox database 44 at 210. The mailbox update 210 can also store the retrieval notification indicator, the notification acknowledgement message preference, and date and time the calling-party-called-party voicemail message was left at the voicemail system 40 in the voice mailbox database 44. The voicemail system 40 can send an indication to the called party terminal 13 that a voicemail message has been left for them at the voicemail system 40 as shown at 212.

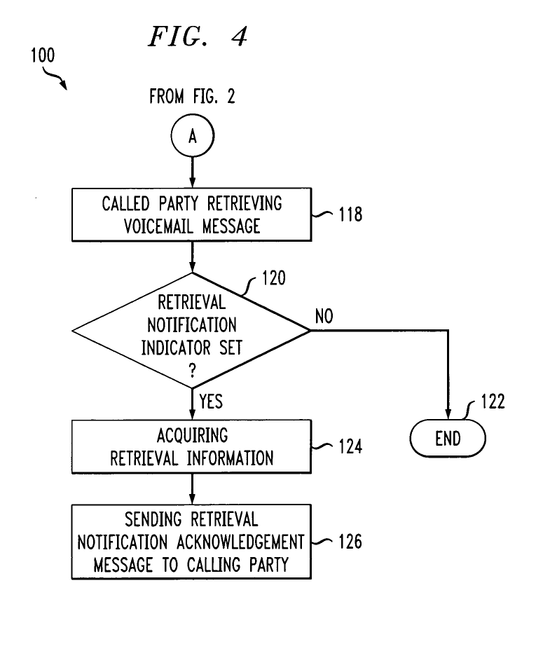

Referring now to FIGS. 3 and 4, the method of message delivery 100 also includes the called party retrieving the calling-party-to-called-party voicemail message at 118. The called party sends a message to the voicemail system 40 at 212 indicating that they want to retrieve their voicemail messages. This can be done in any suitable known manner, such as for example by using their terminal 13 to call the voicemail system 40 and to enter any codes that may be necessary for retrieving their voicemail messages.

The voicemail system 40 queries the voice mailbox database 44 at 216 sending any necessary identification information identifying the called party. The voice mailbox responds at 218 providing the voicemail system 40 with the voicemail messages left for the called party, including the calling-party-to-called-party voicemail message. The voicemail system 40 delivers the called party's voicemail messages, including the calling-party-to-called-party voicemail message, to the called party. For example, the voicemail system 40 can play back the messages recorded and saved on the voice mailbox database 44 to the called party terminal 13 over the network 10.

The voicemail system 40 can determine whether the retrieval notification indicator has been set at 108 above. If the retrieval notification indicator was set, the method can also include acquiring retrieval information at 124 after the called party retrieves the voicemail message at 118. The voicemail system 40 acquires retrieval information which can be sent to the calling party in the voicemail retrieval notification acknowledgement message as described below. The retrieval information can include the phone number of the called party terminal 13 used to retrieve the voicemail message. The retrieval information can also include and the date and time that the called party retrieved the message, also referred to as the retrieval date and time. The voicemail system 40 can obtain the date and time information from when the voicemail system delivers the message to the called party.

The method also includes sending a voicemail retrieval notification acknowledgement message to the calling party indicating that the called party has retrieved the calling-party-to-called-party voicemail message at 126. The voicemail system 40 sends the voicemail retrieval notification acknowledgement message to the serving/home MSC 18 of the calling party at 222. The MSC 18 sends the voicemail retrieval notification acknowledgement message to the calling party terminal 12 at 224. The calling party terminal 12 can be a different terminal than the terminal from which the calling party left the calling-party-to-called-party voicemail message.

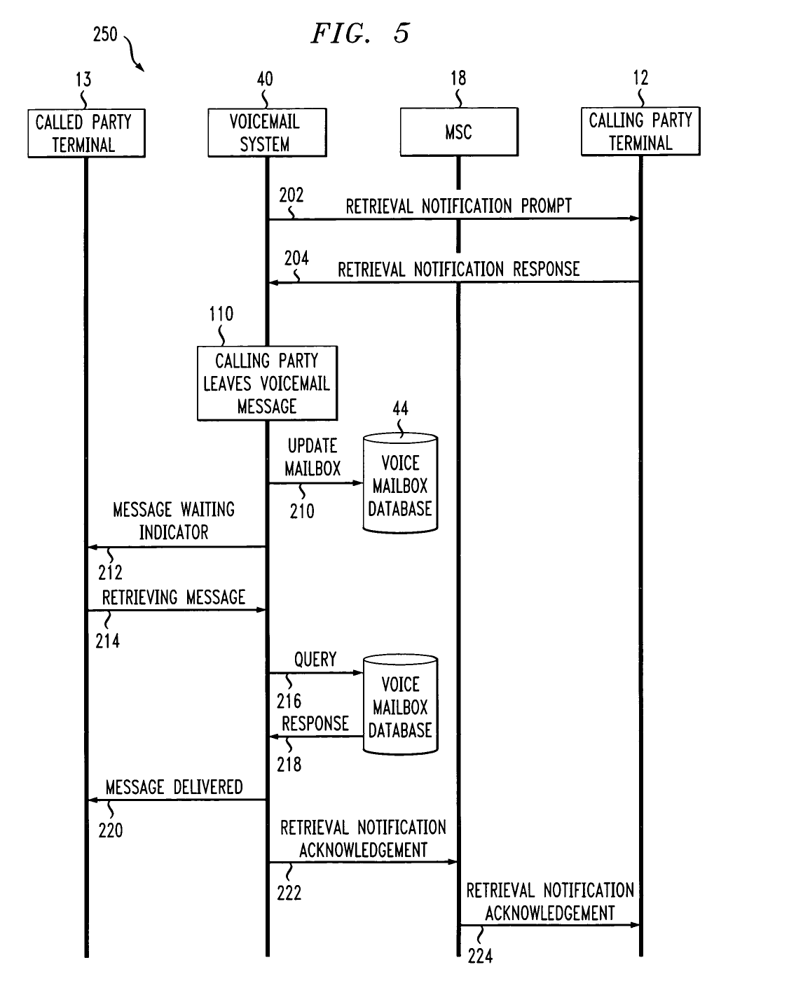

Referring to FIG. 5, the voicemail retrieval notification acknowledgement message can be sent to the calling party terminal 12 via an SMS message as shown in the message flow diagram indicated generally at 250. Messages similar to the messages described in FIG. 3 above are indicated with similar reference numbers. The voicemail system 40 sends a message to the SMS Center 46 at 252 indicating that an SMS voicemail retrieval notification acknowledgement message should be sent to the calling party terminal 12. The message at 252 can include the calling party contact information needed to route the voicemail retrieval notification acknowledgement SMS message to the calling party terminal 12. The SMS Center 46 sends the voicemail retrieval notification acknowledgement SMS message to the calling party terminal at 242.

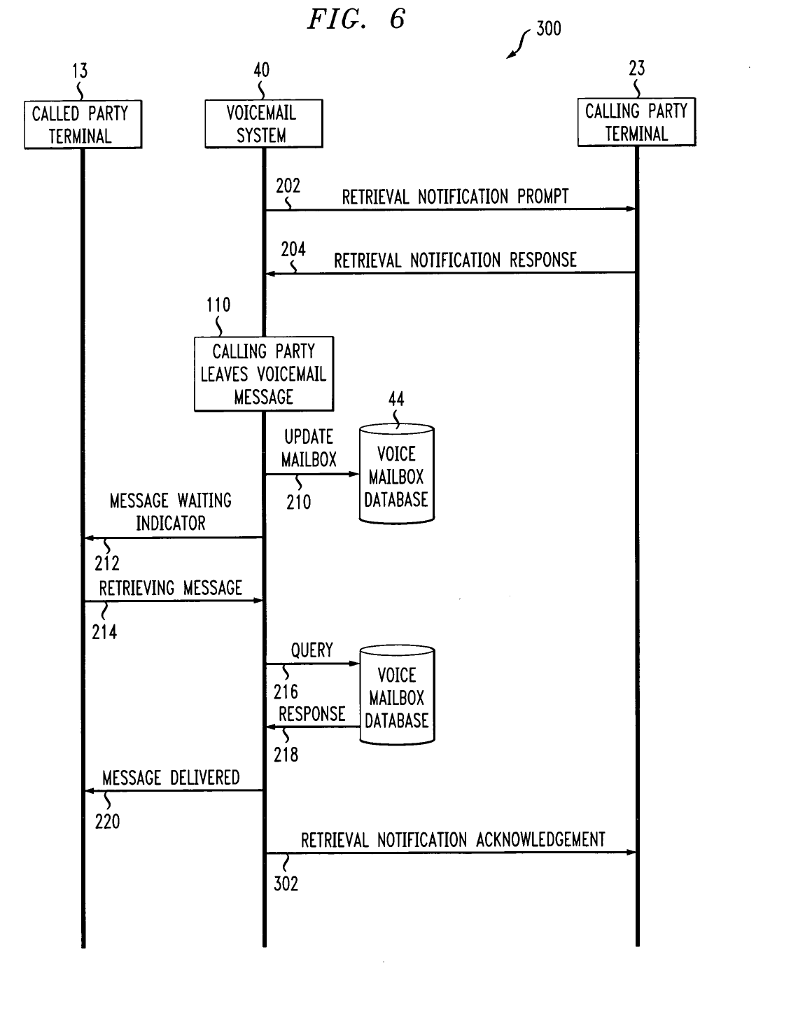

Referring to FIG. 6, the voicemail retrieval notification acknowledgement message can be sent to a wireline calling party terminal 23 via the PSTN as shown in the message flow diagram indicated generally at 300. Messages similar to the messages described in FIG. 3 above are indicated with similar reference numbers. The voicemail retrieval notification acknowledgement message can be saved as a voicemail message for the calling party on the voicemail system 40 and delivered to the calling party terminal at 302 when the calling party retrieves their voicemail messages. The calling party terminal can be a wireline terminal 23 connected to the wireless network 10 via the PSTN or a wireless terminal 12.

Further, it is contemplated that the calling party can subscribe to the voicemail message retrieval notification feature. The MSC 18 can determine that the calling party subscribes to the message delivery feature by checking the calling party subscriber profile 24 which can indicate that a retrieval notification message can be sent to the calling party.

The invention provides notification to the calling party by sending a voicemail retrieval notification acknowledgement message to the calling party indicating that the called party has retrieved the calling-party-to-called-party voicemail message. The voicemail retrieval notification acknowledgement message can include the date and time the called party retrieved the voicemail message.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

1. A method of delivering a message using a wireless communications network voicemail system comprising:
leaving a calling-party-to-called-party voicemail message on the wireless communications network voicemail system;
retrieving the voicemail message by the called party; and
sending a voicemail retrieval notification acknowledgement message to the calling party indicating that the called party has retrieved the calling-party-to-called-party voicemail message.

2. The method defined in claim 1, wherein the voicemail retrieval notification acknowledgement message is a Short Message Service (SMS) message and the sending step further comprises sending the SMS message to the calling party terminal.

3. The method defined in claim 1, wherein the voicemail retrieval notification acknowledgement message is a voice message sending step further comprises sending the voicemail message to the calling party terminal.

4. The method defined in claim 1, wherein the voicemail retrieval notification acknowledgement message is a voicemail message and the sending step further comprises sending the voicemail message to the calling party's voicemail.

5. The method defined in claim 1 further comprising the calling party requesting voicemail retrieval notification.

6. The method defined, in claim 5 wherein the requesting step further comprises:
sending a retrieval notification prompt to the calling party; and
receiving a retrieval notification response from the calling party indicating that the calling party is requesting voicemail retrieval notification.

7. The method defined in claim 5 further comprising:
setting a retrieval notification indicator indicating that a voicemail retrieval notification acknowledgement is to be sent to the calling party after the retrieving step.

8. The method defined in claim 1 further comprising associating calling party contact information with the voicemail message.

9. The method defined in claim 1 further comprising:
determining the retrieval date and time when called party retrieved the calling-party-to-called-party voicemail message; and
including the retrieval date and time in the voicemail retrieval notification acknowledgement message.

10. The method defined in claim 1 further comprising:
including the called party phone number in the voicemail retrieval notification acknowledgement message.

11. The method defined in claim 1 wherein the voicemail retrieval notification acknowledgement message includes the date and time the calling party left the voicemail message in the leaving step.

12. A method of delivering a message using a wireless communications network comprising:
sending a voicemail retrieval notification acknowledgement message to a calling party indicating that a called party has retrieved a calling-party-to-called-party voicemail message.

13. A system for voicemail retrieval notification comprising:
means for sending a voicemail retrieval notification acknowledgement message to the calling party indicating that the called party has retrieved the calling-party-to-called-party voicemail message.

14. The system defined in claim 13 further comprising:
means for leaving a calling-party-to-called-party voicemail message on the wireless communications network voicemail system; and
means for retrieving the voicemail message by the called party.

15. The system defined in claim 13 further comprising:
means for sending a voicemail retrieval notification acknowledgement message to the calling party indicating the time and date when the called party retrieved the calling-party-to-called-party voicemail message.

16. The system defined in claim 13 further comprising:
means for sending an SMS message to the calling party, wherein the voicemail retrieval notification acknowledgement message is an SMS message.

17. The system defined in claim 13 further comprising:
means for sending a voicemail message to the calling party, wherein the voicemail retrieval notification acknowledgement message is a voicemail message.

18. The system defined in claim 13 further comprising:
means for sending a voicemail message to the calling party, wherein the voicemail retrieval notification acknowledgement message is a voice message.
